(19) United States
(12) Patent Application Publication
(10) Pub. No.: US 2023/0267226 A1
(43) Pub. Date: Aug. 24, 2023

(54) BLOCKCHAIN-BASED OPERATIONS

(71) Applicant: HEWLETT-PACKARD DEVELOPMENT COMPANY, L.P., Spring, TX (US)

(72) Inventors: Helen Balinsky, Bristol (GB); Derek Lukasik, Fort Collins, CO (US)

(73) Assignee: HEWLETT-PACKARD DEVELOPMENT COMPANY, L.P., Spring, TX (US)

(21) Appl. No.: 17/679,813

(22) Filed: Feb. 24, 2022

(51) Int. Cl. G06F 21/62; H04L 9/40; G06F 21/60

(52) U.S. Cl. CPC G06F 21/6227; H04L 63/08; G06F 21/604

(57) ABSTRACT

In one example in accordance with the present disclosure, an electronic device is described. The example electronic device includes a processor and a memory communicatively coupled to the processor. The memory stores executable instructions that when executed cause the processor to store data received from a first entity in a blockchain ledger based on a smart contract. The instructions also cause the processor to verify, with the smart contract, that a second entity is authorized to receive the data. The instructions further cause the processor to send the data to the second entity in response to verifying the second entity is authorized to receive the data.

### BACKGROUND

Electronic devices may communicate with each other. In some examples, electronic devices may communicate with each other over a network. Some examples of networks include a local area network, a wide area network and the internet.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an electronic device to perform blockchain-based operations, according to an example.

FIG. 2 is a block diagram of a system for performing blockchain-based operations, according to an example.

FIG. 3 is a block diagram of a system for performing blockchain-based operations, according to an example.

FIG. 4 is a flow diagram illustrating a method for performing blockchain-based operations, according to an example.

FIG. 5 depicts a non-transitory machine-readable storage medium for performing blockchain-based operations, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Data may be exchanged between devices in a distributed environment. For example, a first device may provide data to a second device. In some examples, the data may be used to facilitate operations between devices. For instance, the data may include cryptographic material or configuration data used to establish communication between devices in a network environment.

Some examples of cryptographic material includes security keys (e.g., a public key used in encrypted communications) and certificates. Certificates may be used to establish the identity of web services on a network (e.g., the internet). As used herein, a certificate (also referred to as a digital certificate, public key certificate, or identity certificate) is an electronic file used to prove ownership of a private key. In some examples, the certificate may include a public key. A proof of possession exchange may be used to prove that an entity holding the certificate controls the corresponding private key. Trust in the process of issuing and maintaining certificates is expected by businesses and individuals to continue using web services. With that basic trust, users may be confident that malicious individuals cannot intercept or otherwise interfere with interactions over an otherwise untrusted network infrastructure (e.g., the internet).

In some cases, devices or services may transport sensitive information. For example, web applications may leverage certificates to create secure channels. Issuing, installing, revoking, and removing those security certificates may involve manual operations and configurations. These manual processes may become troublesome as the number of host devices, servers, and services increase. In some examples, data may include configuration data used to configure a device to operate in a network environment.

Security is a concern for computing. For example, devices and services may exchange sensitive information with each other while keeping the sensitive information secret. Devices and services may provide secure communication channels by leveraging mechanisms such as the Secure Sockets Layer (SSL) or transport layer security (TLS) protocols. These protocols use asymmetric encryption to share secret keys between endpoints and to encrypt communications.

In some examples, organizations may perform manual configuration of devices to join a distributed system (e.g., a computing cluster) or network. This may prove challenging for an organization. For example, system administrators may physically carry a memory device (e.g., USB flash drive) that stores configuration information to each computer that is to join a distributed system. Infrastructure operations involving services distributed across multiple devices may entail an administrator providing trusted data to those services on each device.

In an example of cluster management, to add devices (referred to as nodes) to a cluster, an administrator may retrieve a join token from the cluster master and may use the join token at a new node to join the cluster. Interested parties, the cluster master, and the new worker node, then exchange cryptographic material via a side channel (referred to as a sneaker net) to successfully add a new node. Once enrollment of the node is complete, there is no record of the operation. This same process is applied to distributed systems where a given service maintains a registry of configuration and authorization information. An administrator populates the registry with sensitive data before the operation of the system can be trusted.

As seen by these examples, the exchange of data for computing operations and communication involves challenges for computing applications. The present specification describes examples of automated operations based on a blockchain ledger. In some examples, data may be exchanged between devices using blockchain as the substrate. For example, blockchain may provide a ledger to record data (e.g., cryptographic material, configuration information, etc.). Smart contracts may be used to keep the integrity of the operations.

In some examples, a smart contract and blockchain ledger may be used for data distribution. When managing data distribution, a single blockchain ledger may be used as a part of a smart contract. As used herein, a “smart contract” may include instructions stored on an electronic device that automatically execute based on conditions being met. In the examples described herein, the process of data distribution may be fully automated. A blockchain smart contract enforces a structured workflow between machines and between human and machine using public identities stored in the blockchain.

A blockchain ledger can record transactions and keep a trusted record of the transactions. Once recorded in the blockchain ledger, a transaction cannot be altered. A blockchain is a digital ledger of cryptographically signed transactions that are grouped into blocks. Each block in the blockchain ledger is cryptographically linked to the previous block (making it tamper evident) after validation and undergoing a consensus decision. As new blocks are added, older blocks become more difficult to modify, thus creating tamper resistance. New blocks may be replicated across copies of the blockchain ledger, and any conflicts may be resolved automatically using established rules.

The present specification describes examples to securely automate the process of distributing information to relevant machines and services in a distributed system. In an example, the present specification describes an electronic device. The electronic device includes a processor and a memory communicatively coupled to the processor. The memory stores executable instructions that when executed cause the processor to store data received from a first entity in a blockchain ledger based on a smart contract. The processor verifies, with the smart contract, that a second entity is authorized to receive the data. The processor sends the data to the second entity in response to verifying the second service is authorized to receive the data.

In another example, the present specification also describes a method. The method includes recording, in a blockchain ledger, a master node assignment of a first entity to be a master node in a computing cluster. The method also includes recording, in the blockchain ledger, a worker node assignment of a second entity to be a worker node in the computing cluster. The method further includes storing a public key of the second entity in the blockchain ledger. The method additionally includes storing an encrypted token to join a computing cluster, the token being encrypted by the first entity using the public key of the second entity stored in the blockchain ledger. The method also includes enforcing an operation between the first entity and the second entity based on a first entity identifier and a second entity identifier stored in the blockchain ledger.

In yet another example, the present specification also describes a non-transitory machine-readable storage medium that includes instructions, when executed by a processor of an electronic device, cause the processor to record, in a blockchain ledger, a command to remove a second entity from a computing cluster. The processor receives a removal acknowledgement from a first entity in response to the second entity being removed from the computing cluster. The processor records the removal acknowledgement from the first entity in the blockchain ledger. The processor blocks access of the second entity to the blockchain ledger in response to the command to remove a second entity from a computing cluster.

As used in the present specification and in the appended claims, the term “processor” may be a controller, an application-specific integrated circuit (ASIC), a semiconductor-based microprocessor, a central processing unit (CPU), and a field-programmable gate array (FPGA), and/or other hardware device.

As used in the present specification and in the appended claims, the term “memory” may include a computer-readable storage medium, which computer-readable storage medium may contain, or store computer-usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the respective component, cause the component to implement the functionality described herein.

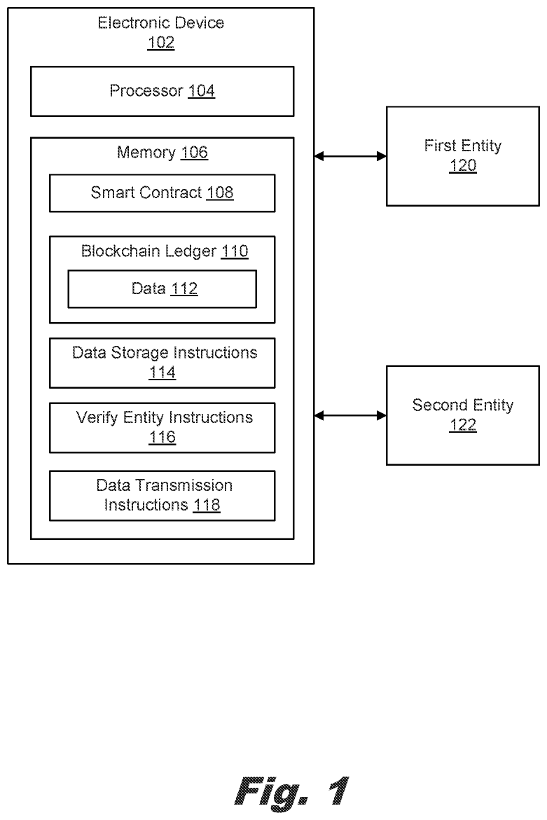

Turning now to the figures, FIG. 1 is a block diagram of an electronic device 102 to perform blockchain-based operations, according to an example. As described above, the electronic device 102 includes a processor 104. The processor 104 of the electronic device 102 may be implemented as dedicated hardware circuitry or a virtualized logical processor. The dedicated hardware circuitry may be implemented as a central processing unit (CPU). A dedicated hardware CPU may be implemented as a single to many-core general purpose processor. A dedicated hardware CPU may also be implemented as a multi-chip solution, where more than one CPU are linked through a bus and schedule processing tasks across the more than one CPU.

In some examples, a memory 106 may be implemented in the electronic device 102. The memory 106 may be dedicated hardware circuitry to host instructions for the processor 104 to execute. In another implementation, the memory 106 may be virtualized logical memory. Analogous to the processor 104, dedicated hardware circuitry may be implemented with dynamic random-access memory (DRAM) or other hardware implementations for storing processor instructions. Additionally, the virtualized logical memory may be implemented in an abstraction layer which allows the instructions to be executed on a virtualized logical processor, independent of any dedicated hardware implementation.

The electronic device 102 may also include instructions. The instructions may be stored in the memory 106 and implemented in a platform-specific language that the processor 104 decodes and executes. The instructions may be stored in the memory 106 during execution. The instructions may include operations executable by the processor 104 to perform blockchain-based operations.

The instructions include data storage instructions 114 that when executed enable the processor 104 to store data 112 received from a first entity 120 in a blockchain ledger 110 based on a smart contract 108. As used herein, a “blockchain ledger” is a series of records (also referred to as blocks) that are linked together using cryptography. Each record in the blockchain ledger 110 may be signed with a cryptographic hash of the previous record. The data 112 in any given record of the blockchain ledger 110 cannot be altered retroactively without altering all subsequent records. As used herein, recording a record to the blockchain ledger 110 may include generating a new record, saving information in the new record and signing the new record with the cryptographic hash of the previous record.

As used herein, a “smart contract” may include instructions stored in the memory 106 of the electronic device 102. The instructions for the smart contract 108 automatically execute based on conditions being met. In the examples described herein, the process of data distribution may be fully automated by the smart contract 108.

As used herein, an “entity” includes a device or service. Thus, the first entity 120 may be a computing device or a service. As used herein, a “service” includes computing functionality that is executed on a single computing device (e.g., a server) or multiple computing devices. In some examples, an entity may communicate with the electronic device 102 in a network environment. In some examples, an entity may be a service implemented by the electronic device 102.

In some examples, the instructions to store the data include executable instructions that when executed cause the processor 104 to record a first entity identifier for the first entity 120 and a second entity identifier for a second entity 122 in the blockchain ledger 110. In some examples, devices and services may be onboarded to the blockchain ledger 110 to establish a trusted public identity for each system. In some examples, the identifier may include unique data (e.g., a cryptographic key, certificate, etc.) that is used by the smart contract 108 to identify an entity (e.g., the first entity 120, second entity 122, etc.). The first entity identifier and the second entity identifier may be written as entries to the blockchain ledger 110.

In some examples, the instructions to store the data include executable instructions that when executed cause the processor 104 to verify, with the smart contract 108, that the first entity 120 is authorized to store the data 112 in the blockchain ledger 110 based on the first entity identifier recorded in the blockchain ledger 110. Thus, upon receiving a request from the first entity 120 to write data 112 to the blockchain ledger 110, the smart contract 108 may verify that the first entity identifier included with the request matches the first entity identifier stored in the blockchain ledger 110.

Upon verifying the identity of the first entity 120, the smart contract 108 may determine that the first entity 120 is authorized to store the data 112 to the blockchain ledger 110. For example, the smart contract 108 may include a list of operations that the first entity 120 and the second entity 122 are permitted to perform with respect to the blockchain ledger 110. For example, the smart contract 108 may be configured with instructions that allow the first entity 120 and second entity 122 to store and retrieve the data 112 from the blockchain ledger 110, while preventing other entities from accessing the data 112 on the blockchain ledger 110.

In some examples, the data 112 may include security-sensitive information. For example, the data 112 may include cryptographic material (e.g., a token) to perform a computing operation. In some examples, the data 112 may include configuration data for a service. For example, the configuration data may include instructions to configure a service running on a device. In some examples, the configuration data may include instructions for an entity to join a computing cluster.

The verify entity instructions 116 may cause the processor 104 to verify, with the smart contract 108, that the second entity 122 is authorized to receive the data 112. For example, the instructions to verify that the second entity 122 is authorized to receive the data 112 may include executable instructions that when executed cause the processor 104 to determine that an identifier sent by the second entity 122 matches the second entity identifier recorded in the blockchain ledger 110.

Data transmission instructions 118 may cause the processor 104 to send the data 112 to the second entity 122 in response to verifying the second entity 122 is authorized to receive the data 112. For example, if the identifier sent by the second entity 122 matches the second entity identifier recorded in the blockchain ledger 110, then the smart contract 108 may allow the data 112 to be sent to the second entity 122. The processor 104 may retrieve the data 112 from the blockchain ledger 110 and sends the data 112 to the second entity 122. In some examples, the second entity 122 may perform an operation using the data 112. For example, the second entity 122 may join a computing cluster using instructions and/or cryptographic material included in the data 112.

In some examples, the receipt of the data 112 from the first entity 120 and transmission of the data 112 to the second entity 122 may be recorded as entries in the blockchain ledger 110. Thus, the blockchain ledger 110 may be used to log transactions of data 112 by the first entity 120 and the second entity 122. This provides an audit trail of transactions in the blockchain ledger 110.

As seen in these examples, the blockchain ledger 110 may serve as a trusted authority among the entities (e.g., the first entity 120 and the second entity 122) of a distributed system. The blockchain smart contract 108 may define and enforce a workflow for transactions related to the operation of the distributed system.

An example of a sequence of operations using data 112 distributed through the blockchain ledger 110 is now described. An authorized party (e.g., a service or individual) may issue a command (C) that is recorded as a transaction in the blockchain ledger 110. The command may indicate entities (e.g., the first entity 120 and/or the second entity 122) that are to perform operations. Affected entities (e.g., the first entity 120 and/or the second entity 122) may be notified (e.g., either via an event system or polling) that the data 112 is to be transferred. In some examples, the entities are expected to respond to command C in a specified period of time.

If the data 112 includes cryptographic material, then the first entity 120 and/or the second entity 122 may share the cryptographic material through a sequence of blockchain transactions described above. In some examples, a recipient (e.g., the second entity 122) of the data 112 may first share its public key before a sender (e.g., the first entity 120) shares the cryptographic material.

The affected entities may execute the command (C) using operations associated with the command (C) and the data 112 (e.g., cryptographic material). Upon successful execution, the first entity 120 and/or the second entity 122 may acknowledge successful completion of command (C) by submitting a corresponding blockchain transaction to the blockchain ledger 110. In case of failure, an entity may report the failure status and an authorized party may take a mitigation action (e.g., retry, continue to wait, change command, reset, signal alert, etc.).

In the above example, the sequence of operations may be enforced by the blockchain smart contract 108. The flow of the process may occur by nodes (e.g., the first entity 120 and/or the second entity 122) periodically polling the blockchain ledger 110 for operations that are to be performed. In some examples, a notification system may be used to implement an event-based system to notify entities (e.g., the first entity 120 and/or the second entity 122) of operations that are to be performed.

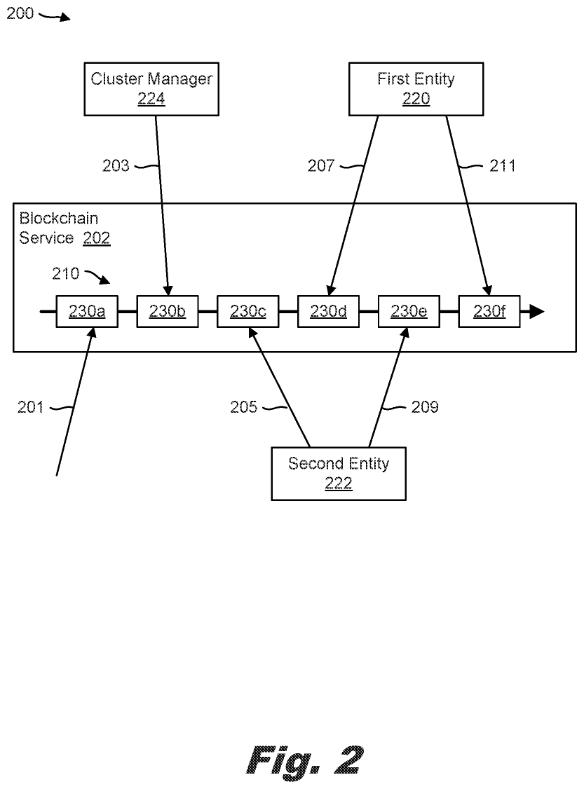

FIG. 2 is a block diagram of a system 200 for performing blockchain-based operations, according to an example. The system 200 includes a blockchain service 202 that maintains a blockchain ledger 210. In some examples, the blockchain service 202 may be implemented according to the electronic device 102 described in FIG. 1. In some examples, the sequence of operations described in this example is enforced by the blockchain smart contract executed by the blockchain service 202.

In the example of FIG. 2, the blockchain ledger 210 may be used for computing cluster management. For example, this example describes using the blockchain ledger 210 to join a new node (e.g., the second entity 222) to a computing cluster. As used herein a “computing cluster” includes a group of multiple computing resources that work together to perform computing tasks. For example, portions of a computing job may be assigned to different nodes in a computing cluster.

At 201, the identities of the first entity 220, the second entity 222, and the cluster manager 224 may be saved as a transaction 230a in the blockchain ledger 210. The identities may be used by the smart contract to authenticate access to the blockchain ledger 210 and to authorize entities (e.g., the cluster manager 224) to issue commands to other entities. The cluster manager 224 may be an entity that is given an authorized role assignment in 201 to issue commands to other entities to form a computing cluster. Also, at 201, the first entity 220 may be assigned the role of master node.

At 203, the cluster manager 224 may create a transaction 230b in the blockchain ledger 210 assigning a worker node to the computing cluster. In this example, the second entity 222 may be assigned the role of worker node in the computing cluster. The worker node (e.g., second entity 222) is notified and sees the cluster assignment transaction 230b.

At 205, the second entity 222 may write its public key to the blockchain ledger 210 in a transaction 230c. The master node (e.g., the first entity 220) may be notified that the second entity 222 is to join the computing cluster and has written its public key to the blockchain ledger 210. The first entity 220 may verify transaction 230b and transaction 230c and retrieves worker public key from transaction 230c in the blockchain ledger 210.

At 207, the first entity 220 may generate a token to join the computing cluster. The first entity 220 may encrypt the token with the public key of the second entity 222 (e.g., the worker node). The first entity 220 may then submit the token to the blockchain ledger 210 as transaction 230d.

The second entity 222 may be notified that the token is available. The second entity 222 may read transaction 230d to receive the token. The second entity 222 may decrypt the token using its private key. The worker node (e.g., the second entity 222) executes the process of joining the computing cluster using the decrypted token. The worker node (e.g., the second entity 222) may send a request to join the computing cluster using the token. The master node (e.g., the first entity 220) accepts the worker node join request.

At 209, the worker node (e.g., the second entity 222) acknowledges completion of the join operation in transaction 230e. The master node (e.g., the first entity 220) acknowledges completion of the join operation in transaction 230f. In case of failure, the worker node and/or the master node may retry the join operation or may otherwise report failure conditions.

It should be noted that the flow of the process described in FIG. 2 may occur by the nodes (e.g., the first entity 220 and/or the second entity 222) periodically polling the blockchain ledger 210 for work, or a notification system may be used to notify the nodes of in an event-based system.

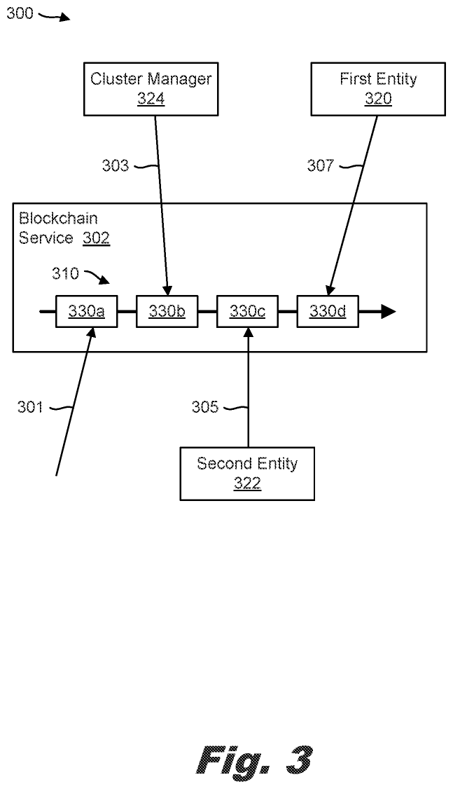

FIG. 3 is a block diagram of a system 300 for performing blockchain-based operations, according to an example. The system 300 includes a blockchain service 302 that maintains a blockchain ledger 310. In some examples, the blockchain service 302 may be implemented according to the electronic device 102 described in FIG. 1 and the blockchain service 202 described in FIG. 2. In some examples, the sequence of operations described in this example is enforced by the blockchain smart contract executed by the blockchain service 302. This example describes using the blockchain ledger 310 to remove a new node (e.g., the second entity 222) from an existing computing cluster.

At 301, the identities of the first entity 320, the second entity 322, and the cluster manager 324 may be saved as a transaction 330a in the blockchain ledger 310. This may be accomplished as described in FIG. 2.

At 303, the cluster manager 324 creates a transaction 330b in the blockchain ledger 310 removing a worker node (e.g., the second entity 322) from the computing cluster. The worker node is notified (e.g., by the blockchain service 302) of its removal. For example, the second entity 322 may read the cluster removal transaction 330b. It should be noted no cryptographic material is exchanged to remove the second entity 322 from the computing cluster.

At 305, the second entity 322 removes itself from the computing cluster. The second entity 322 stops responding to cluster operation requests. The second entity 322 acknowledges completion of the cluster removal operation by submitting blockchain transaction 330c.

At 307, the first entity 320 (e.g., the master node) removes the second entity 322 from the computing cluster and stops assigning jobs to the second entity 322. The first entity 320 acknowledges completion of the cluster removal operation by submitting blockchain transaction 330d.

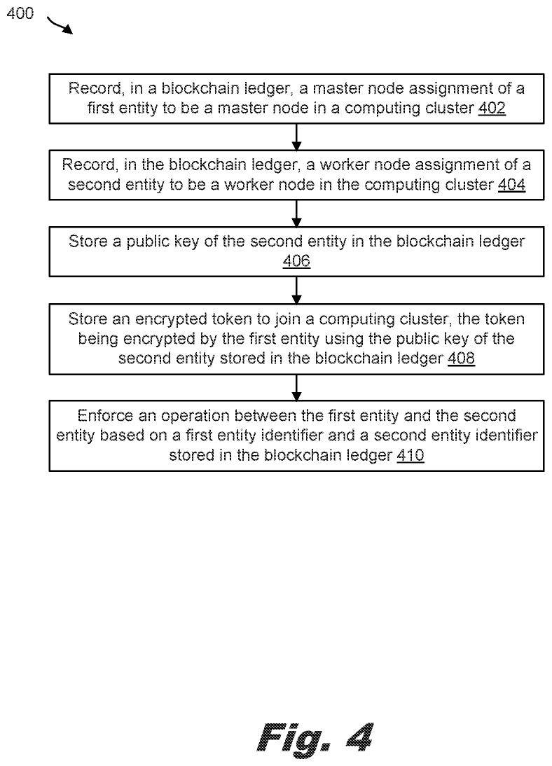

FIG. 4 is a flow diagram illustrating a method 400 for performing blockchain-based operations, according to an example. In some examples, the method 400 may be performed by a blockchain service, such as the blockchain service 202 described in FIG. 2. In some examples, the blockchain service may include a blockchain ledger to store data (e.g., cryptographic material, configuration information) and record transactions. The blockchain service may implement a smart contract to automate the blockchain-based operations.

At 402, the blockchain service 202 may record, in a blockchain ledger 210, a master node assignment of a first entity 220 to be a master node in a computing cluster. For example, a cluster manager 224 may issue the master node assignment. The master node assignment may be recorded as a transaction in the blockchain ledger 210.

In some examples, the blockchain service 202 may record a first entity identifier and a second entity identifier to the blockchain ledger 210. In some examples, the first entity identifier may be a public identity unique to the first entity 220. The second entity identifier may be a public identity unique to the second entity 222.

At 404, the blockchain service 202 may record, in the blockchain ledger 210, a worker node assignment of a second entity 222 to be a worker node in the computing cluster. The cluster manager 224 may issue the worker node assignment. The worker node assignment may be recorded as a transaction in the blockchain ledger 210.

At 406, the blockchain service 202 may store a public key of the second entity 222 in the blockchain ledger 210. For example, the second entity 222 may be notified of the worker node assignment. The second entity 222 may write the public key to the blockchain ledger 210 in response to receiving the worker node assignment. For example, the second entity 222 may then send its public key to the blockchain service 202. The blockchain service 202 may record the public key of the second entity 222 in the blockchain ledger 210.

At 408, the blockchain service 202 may store an encrypted token to join a computing cluster. For example, the token may be encrypted by the first entity 220 using the public key of the second entity 222 stored in the blockchain ledger 210. The blockchain service 202 may authorize the second entity 222 to receive the token to join the computing cluster from the blockchain ledger 210 based on the second entity identifier stored in the blockchain ledger 210. For example, the second entity 222 may communicate its identifier to the blockchain service 202. The blockchain service 202 may verify that the received identifier matches the stored second entity identifier before sending the token to the second entity 222.

In some examples, the blockchain service 202 may receive an acknowledgement in response to the second entity 222 joining the computing cluster. For example, the first entity 220 and/or the second entity 222 may send an acknowledgement to the blockchain service 202 when the second entity 222 joins the computing cluster. The blockchain service 202 may record the acknowledgement to the blockchain ledger 210.

At 410, the blockchain service 202 may enforce an operation between the first entity 220 and the second entity 222 based on the first entity identifier and the second entity identifier stored in the blockchain ledger 210. For example, the blockchain service 202 may use a smart contract to validate whether the first entity 220 and the second entity 222 are allowed to perform an operation using the blockchain ledger 210. In an example, the smart contract may allow the first entity 220 to record the join token if an identifier sent by the first entity 220 matches the first entity identifier recorded in the blockchain ledger 210. The smart contract may allow the second entity 222 to record its public key in the blockchain ledger 210 and/or retrieve the join token from the blockchain ledger 210 if an identifier sent by the second entity 222 matches the second entity identifier recorded in the blockchain ledger 210.

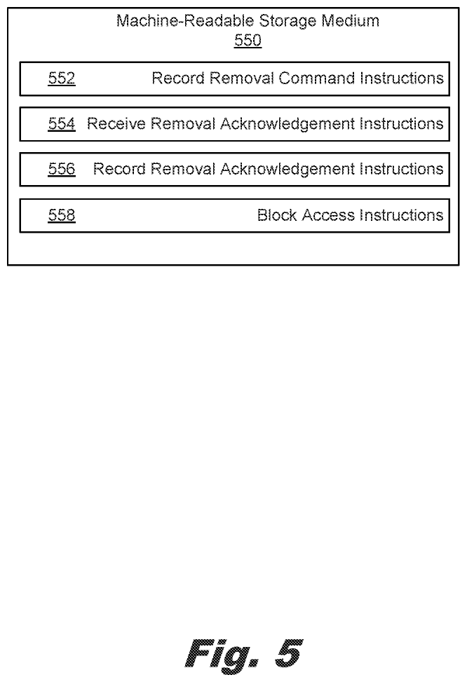

FIG. 5 depicts a non-transitory machine-readable storage medium 550 for performing blockchain-based operations, according to an example. To achieve its desired functionality, an electronic device 102 includes various hardware components. Specifically, an electronic device 102 includes a processor and a machine-readable storage medium 550. The machine-readable storage medium 550 is communicatively coupled to the processor. The machine-readable storage medium 550 includes a number of instructions 552, 554, 556, 558 for performing a designated function. The machine-readable storage medium 550 causes the processor to execute the designated function of the instructions 552, 554, 556, 558. The machine-readable storage medium 550 can store data, programs, instructions, or any other machine-readable data that can be utilized to operate the electronic device 102. Machine-readable storage medium 550 can store computer readable instructions that the processor of the electronic device 102 can process, or execute. The machine-readable storage medium 550 can be an electronic, magnetic, optical, or other physical storage device that contains or stores executable instructions. Machine-readable storage medium 550 may be, for example, Random Access Memory (RAM), an Electrically Erasable Programmable Read-Only Memory (EEPROM), a storage device, an optical disc, etc. The machine-readable storage medium 550 may be a non-transitory machine-readable storage medium 550, where the term “non-transitory” does not encompass transitory propagating signals.

Referring to FIG. 5, record removal command instructions 552, when executed by the processor, cause the processor to record, in a blockchain ledger, a command to remove a second entity from a computing cluster. Receive removal acknowledgement instructions 554, when executed by the processor, may cause the processor to receive a removal acknowledgement from a first entity in response to the second entity being removed from the computing cluster. Record removal acknowledgement instructions 556, when executed by the processor, may cause the processor to record the removal acknowledgement from the first entity in the blockchain ledger. Block access instructions 558, when executed by the processor, may cause the processor to block access of the second entity to the blockchain ledger in response to the command to remove a second entity from a computing cluster.

In some examples, the instructions, when executed by the processor, cause the processor to send a first notification to the first entity. The first notification may instruct the first entity to remove the second entity from the computing cluster.

In some examples, the instructions, when executed by the processor, cause the processor to send a second notification to the second entity. The second notification may instruct the second entity to remove itself from the computing cluster and to stop responding to cluster operation requests.

In some examples, the instructions, when executed by the processor, cause the processor to receive a removal acknowledgement from the second entity in response to the second entity being removed from the computing cluster. The processor may record the removal acknowledgement from the second entity in the blockchain ledger.

What is claimed is:

1. An electronic device, comprising:
a processor; and
a memory communicatively coupled to the processor and storing executable instructions that when executed cause the processor to:
store data received from a first entity in a blockchain ledger based on a smart contract;
verify, with the smart contract, that a second entity is authorized to receive the data; and
send the data to the second entity in response to verifying the second entity is authorized to receive the data.

2. The electronic device of claim 1, wherein the executable instructions further cause the processor to record a first entity identifier and a second entity identifier in the blockchain ledger.

3. The electronic device of claim 2, wherein the instructions to store the data comprise executable instructions that when executed cause the processor to verify, with the smart contract, that the first entity is authorized to store the data in the blockchain ledger based on the first entity identifier recorded in the blockchain ledger.

4. The electronic device of claim 2, the instructions to verify that the second entity is authorized to receive the data comprise executable instructions that when executed cause the processor to determine that an identifier sent by the second entity matches the second entity identifier recorded in the blockchain ledger.

5. The electronic device of claim 1, wherein the data comprises cryptographic material.

6. The electronic device of claim 1, wherein the data comprises configuration data for a service.

7. A method, comprising:
recording, in a blockchain ledger, a master node assignment of a first entity to be a master node in a computing cluster;
recording, in the blockchain ledger, a worker node assignment of a second entity to be a worker node in the computing cluster;
storing a public key of the second entity in the blockchain ledger;
storing an encrypted token to join a computing cluster, the token being encrypted by the first entity using the public key of the second entity stored in the blockchain ledger; and
enforcing an operation between the first entity and the second entity based on a first entity identifier and a second entity identifier stored in the blockchain ledger.

8. The method of claim 7, further comprising recording a first entity identifier and a second entity identifier to the blockchain ledger.

9. The method of claim 7, authorizing the second entity to receive the token to join the computing cluster from the blockchain ledger based on the second entity identifier stored in the blockchain ledger.

10. The method of claim 7, further comprising:
receiving an acknowledgement in response to the second entity joining the computing cluster; and
recording the acknowledgement to the blockchain ledger.

11. The method of claim 7, wherein the second entity writes the public key to the blockchain ledger in response to receiving the worker node assignment.

12. A non-transitory machine-readable storage medium comprising instructions, when executed by a processor of an electronic device, cause the processor to:
record, in a blockchain ledger, a command to remove a second entity from a computing cluster;
receive a removal acknowledgement from a first entity in response to the second entity being removed from the computing cluster;
record the removal acknowledgement from the first entity in the blockchain ledger; and
block access of the second entity to the blockchain ledger in response to the command to remove a second entity from a computing cluster.

13. The non-transitory machine-readable storage medium of claim 12, wherein the instructions, when executed by the processor, cause the processor to:
send a first notification to the first entity, the first notification instructing the first entity to remove the second entity from the computing cluster.

14. The non-transitory machine-readable storage medium of claim 12, wherein the instructions, when executed by the processor, cause the processor to:
send a second notification to the second entity, the second notification instructing the second entity to remove itself from the computing cluster and to stop responding to cluster operation requests.

15. The non-transitory machine-readable storage medium of claim 12, wherein the instructions, when executed by the processor, cause the processor to:
receive a removal acknowledgement from the second entity in response to the second entity being removed from the computing cluster; and
record the removal acknowledgement from the second entity in the blockchain ledger.
